(19) United States
(12) Patent Application Publication
(10) Pub. No.: US 2015/0134641 A1
(43) Pub. Date: May 14, 2015

(54) ELECTRONIC DEVICE AND METHOD FOR PROCESSING CLIP OF ELECTRONIC DOCUMENT

(71) Applicant: Kabushiki Kaisha Toshiba, Tokyo (JP)

(72) Inventor: Sachie Yokoyama, Ome-shi (JP)

(73) Assignee: Kabushiki Kaisha Toshiba, Tokyo (JP)

(21) Appl. No.: 14/263,773

(22) Filed: Apr. 28, 2014

(30) Foreign Application Priority Data
Nov. 8, 2013 (JP) 2013-232263

(51) Int. Cl. G06F 17/30

(52) U.S. Cl. CPC G06F 17/30011; G06F 17/30864
USPC 707/722

(57) ABSTRACT

According to one embodiment, an electronic device designates a first clip corresponding to at least a portion of an electronic document as a search key, and acquires information regarding a plurality of contents related to the first clip as a search result. The electronic device displays on a screen the plurality of contents. If a first content of the plurality of content is related to a first element of the first clip, the electronic device displays the first content and a first indication on the screen, the first indication regarding that the first content is related to the first element.

### CROSS-REFERENCE TO RELATED APPLICATIONS

This application is based upon and claims the benefit of priority from Japanese Patent Application No. 2013-232263, filed Nov. 8, 2013, the entire contents of which are incorporated herein by reference.

### FIELD

Embodiments described herein relate generally to a technique for processing a clip of electronic document.

### BACKGROUND

In recent years, various electronic devices such as tablets, PDAs, and smart phones, have been developed. Such types of electronic devices are widely used as tools for browsing various electronic documents (content), e.g., a Web page, presentation data, an electronic book, etc.

Also, in recent years, attention has been focusing on a clipping function, which is a function of storing an electronic document currently displayed, as a clip. Using this clipping function, a user can extract, e.g., a desired article, as a clip, from a Web page, and store the clip in a database.

However, if a large amount of content is stored in the database, there is a case where desired content is hard to find. Thus, it is required to provide a new technique for helping the user find content.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an appearance of an electronic device according to an embodiment;

FIG. 2 is an exemplary block diagram illustrating a system configuration of the electronic device according to the embodiment;

FIG. 3 is an exemplary view for explaining a clipping function which is performed by the electronic device according to the embodiment;

FIG. 4 is an exemplary block diagram illustrating a function configuration of a program which is carried out by the electronic device according to the embodiment;

FIG. 5 is a view illustrating a structure example of clip data which is used by the electronic device according to the embodiment;

FIG. 6 is a view for explaining a display example of a relevant clip which is displayed on a search result screen by the electronic device according to the embodiment;

FIG. 7 is a view for explaining another display example of a relevant clip which is displayed on a search result screen by the electronic device according to the embodiment;

FIG. 8 is an exemplary view for explaining a series of processes including a clip searching process and a clipping process, which are executed by the electronic device according to the embodiment;

FIG. 9 is a view structure an example of a clip list viewing screen which is displayed by the electronic device according to the embodiment;

FIG. 10 is an exemplary view for explaining a process for designating a selected clip on the clip list viewing screen of FIG. 9 as a search key;

FIG. 11 is a view structure an example of a search result screen which is displayed by the electronic device according to the embodiment; and

FIG. 12 is an exemplary flowchart illustrating a procedure of a relevant clip display process which is executed by the electronic device according to the embodiment.

### DETAILED DESCRIPTION

Various embodiments will be described hereinafter with reference to the accompanying drawings.

In general, according to one embodiment, an electronic device comprises a processor and a display processor. The processor designates a first clip corresponding to at least a portion of an electronic document as a search key, the first clip including a first element and a second element, and acquires information regarding a plurality of contents related to the first clip as a search result, the plurality of contents including a first content and a second content. The display processor displays on a screen the plurality of contents. If the first content relates to the first element, the display processor displays the first content and a first indication on the screen, the first indication regarding that the first content is related to the first element. If the second content relates to the second element, the display processor displays the second content and a second indication on the screen, the second indication regarding that the second content is related to the second element.

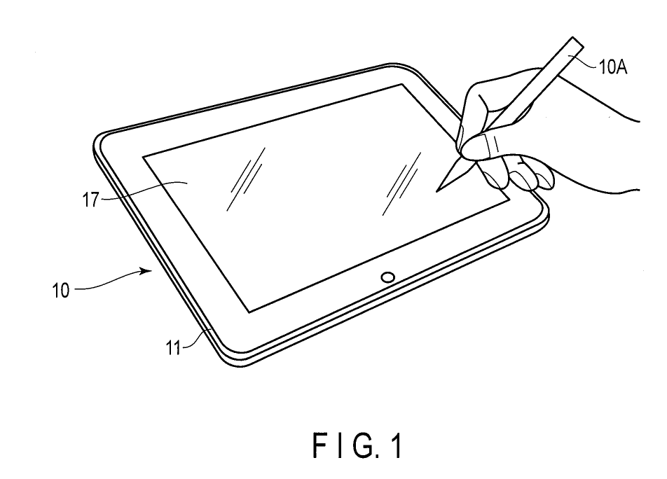

FIG. 1 is a perspective view of an appearance of an electronic device according to an embodiment. The electronic device is a portable electronic device which enables handwriting input to be done with, e.g., a pen (stylus) or a finger. The electronic device can be provided as a tablet computer, a notebook personal computer, a smart phone, a PDA, etc. The following explanation is given with respect to the case where the electronic device is provided as a tablet computer 10. The tablet computer 10 is a portable electronic device which is referred to as a tablet or slate computer. The tablet computer 10 can function as a terminal for use in using, e.g., Web browsing, electronic mail and social network service (SNS). The tablet computer 10, as shown in FIG. 1, comprises a main body 11 and a touch screen display 17. The touch screen display 17 is fixed to the main body 11 in such a way as to be laid over an upper surface thereof.

The main body 11 has a housing formed in the shape of a thin box. The touch screen display 17 incorporates a flat panel display and a sensor configured to detect the position of a pen or finger which contacts a screen of the flat panel display. As the flat panel display, for example, a liquid crystal display (LCD) may be provided. As the sensor, for example, a capacitance-type touch panel or an electromagnetic induction type digitizer can be used. The following explanation is given with respect to the case where a digitizer and a touch panel are incorporated as two kinds of sensors into the touch screen display 17.

The digitizer and the touch panels are provided in such a way to be laid over the screen of the flat panel display. The touch screen display 17 can detect not only a touch operation (contact operation) of a finger on the screen, but a touch operation (contact operation) of a pen 10A on the screen. As the pen 10A, for example, a digitizer pen (electromagnetic induction pen) may be provided. The touch screen display 17 can detect various gestures made by the pen 10A or finger on the screen, such as tapping, dragging, swiping and flicking.

Furthermore, using the pen 10A, the user can do handwriting input onto the touch screen display 17. In the embodiment, some application programs installed on the tablet computer 10 support handwriting input. For example, a Web browser application program (Web browser) installed on the tablet computer 10 enables a stroke of handwriting to be drawn on a Web page currently displayed, in accordance with handwriting input by the user.

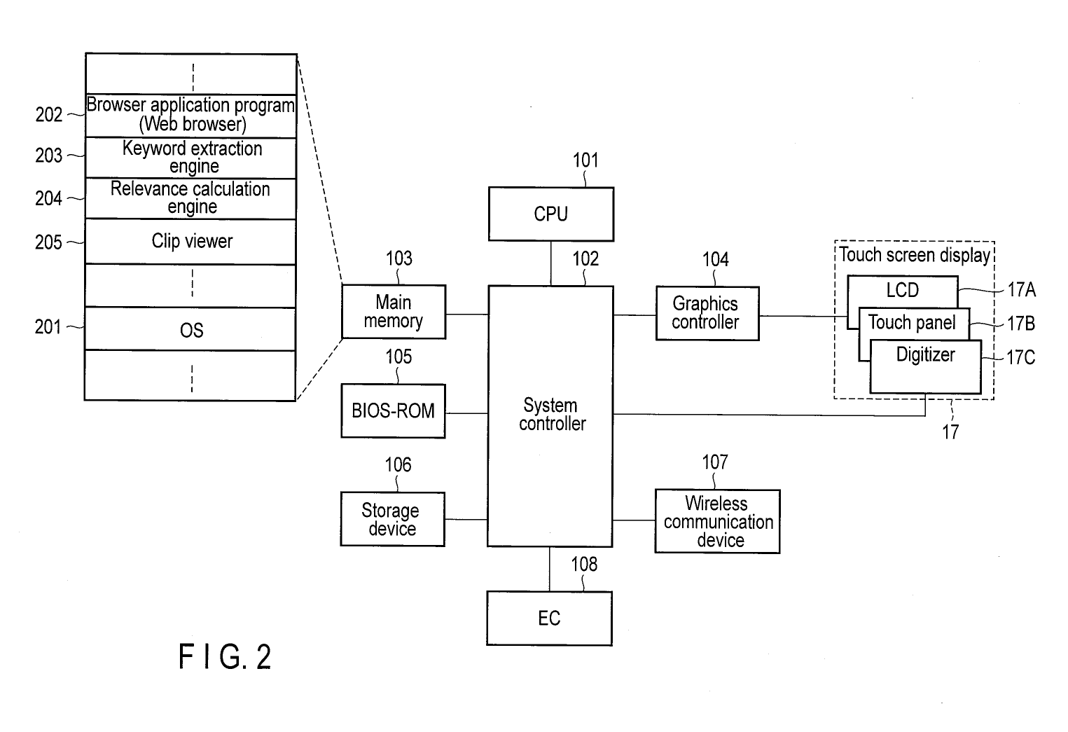

FIG. 2 illustrates a system configuration of the tablet computer 10 in the embodiment.

The tablet computer 10, as shown in FIG. 2, comprises a CPU 101, a system controller 102, a main memory 103, a graphics controller 104, a BIOS-ROM 105, a storage device 106, a wireless communication device 107, an embedded controller (EC) 108, etc.

The CPU 101 is a processor configured to control operations of various modules provided in the tablet computer 10. The CPU 101 executes various programs loaded from the storage device 106 into the main memory 103. The programs to be executed by the CPU 101 include an operating system (OS) 201 and various application programs. The application programs include a browser application program (Web browser) 202, a keyword extraction engine 203, a relevance calculation engine 204, a clip viewer 205, etc.

The browser application program (Web browser) 202 has a function of acquiring data of a Web page from a Web server, a function of displaying the Web page on the screen, and a function of executing a clipping process. The clipping process is a function of storing in a storage medium, a clip (also referred to as clip data) corresponding to at least a portion of an electronic document (digital document) currently displayed. In other words, the clip corresponds to a certain electronic document or a portion of the electronic document, and as the clip, an entire page of the electronic document or a portion of the page thereof is stored. The types of electronic documents to which the clipping function can be applied are not limited; however, as examples of the electronic document, a Web page, presentation data, an electronic book, document data produced with a word processor, etc., are present.

The keyword extraction engine 203 extracts keywords from an electronic document to be processed, using techniques of, e.g., a morphological analysis and a semantic analysis. To be more specific, the keyword extraction engine 203 receives the electronic document to be processed, from the browser application program 202, then extracts the above keywords from the received electronic document, and outputs the extracted keywords to the browser application program 202. A word may be applied as a keyword, and for example, a word representative of the electronic document to be processed may be applied. Furthermore, the keyword extraction engine 203 can output scores (weights) respectively associated with the above extracted keywords to the browser application program 202. It should be noted that a score (weight) given to a certain keyword in the electronic document to be processed indicates a degree of importance of the keyword for the electronic document. It may be set that the higher the importance of the keyword, i.e., the more clearly the keyword expresses the feature of the document to be processed and the higher the representiveness of the keyword for the document, the higher the score of the keyword.

The relevance calculation engine 204 calculates a degree of relevance between electronic documents. The degree of relevance between the electronic documents can be calculated by applying various arbitrary existing techniques capable of determining the relevance between electronic documents. In the embodiment, the degree of relevance between electronic documents, i.e., a relevance score between the electronic documents, may be calculated using a plurality of keywords extracted from a certain electronic document and a plurality of keywords extracted from another electronic document.

The clip viewer 205 performs a processing for displaying a plurality of clips on the screen. To be more specific, the clip viewer 205 has a function of causing all clips stored in the storage medium to be viewed. The clip viewer 205 display a view (clip list viewing screen) which enables the clips stored in the storage medium to be viewed. Each clip, as described above, corresponds to at least portions of an electronic document. As such a clip, a Web clip may be applied. The Web clip is a clip extracted from a Web page. That is, the Web clip is a clip (clip data) corresponding to at least a portion of the Web page.

Furthermore, the CPU 101 also executes a basic input output system (BIOS) stored in the BIOS-ROM 105. The BIOS is a program for controlling hardware.

The system controller 102 is a device which connects a local bus of the CPU 101 and various components. The system controller 102 incorporates a memory controller configured to perform an access control of the main memory 103. Also, the system controller 102 has a function of communicating with the graphics controller 104 through a serial bus or the like.

The graphics controller 104 is a display controller configured to control an LCD 17A used as a display monitor of the tablet computer 10. A display signal produced by the graphics controller 104 is transmitted to the LCD 17A. The LCD 17A displays a screen image based on the display signal. At an upper layer of the LCD 17A, a touch panel 17B is disposed as a first sensor configured to detect the position of a finger which contacts the screen. At a lower layer of the LCD 17A, a digitizer 17C is disposed as a second sensor configured to detect the position of the pen 10A which contacts on the screen. The touch panel 17B is a capacitance type of pointing device configured to do input onto the screen of the LCD 17A. The position, movement, etc., of the finger contacting the screen are detected by the touch panel 17B. The digitizer 17C is an electromagnetic induction type of pointing device configured to do input onto the screen of the LCD 17A. The position, movement, etc. of the pen 10A contacting the screen are detected by the digitizer 17C.

The OS 201 issues, in corporation with a driver program for controlling the touch panel 17B, an input event indicating contact of the finger with the screen and the contact position of the finger. Also, the OS 201 issues, in corporation with a driver program for controlling the digitizer 17C, an input event indicating contact of the pen 10A with the screen and the contact position of the pen 10A.

The wireless communication device 107 is a device configured to execute wireless communication such as wireless LAN or 3G mobile communication.

The EC 108 is a one-chip microcomputer including an embedded controller for power management. The EC 108 has a function of turning on or off the tablet computer 10 in accordance with an operation of a power button by the user.

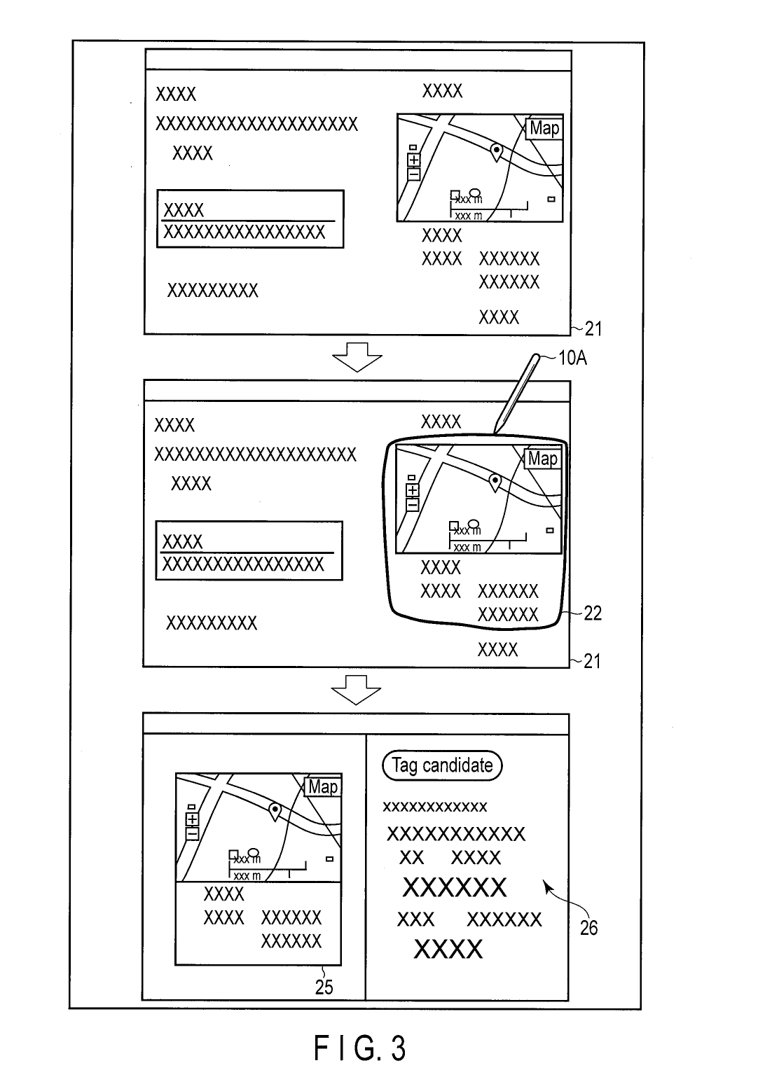

FIG. 3 is a view for use in explaining the clipping process.

The following explanation is given with respect to the case where a clip is extracted from an electronic document (Web page) currently displayed.

On the screen, an electronic document (Web page) 21 including a text and an image is displayed. The user launches, e.g., the browser application program 202 and performs net-surfing to find a desired web page 21, and can have the desired web page 21 displayed on the screen.

There is a case where while viewing a Web page 21, the user finds interesting part or part to be utilized later of the web page 21, and wishes to have it stored. In this case, using, e.g., the pen 10A, the user performs a clipping operation for designating a clip area 22 in a document displayed. As the clip area 22, an area defined by a freehand frame or a rectangular frame which is drawn on the Web page 21 in accordance with movement of the pen 10A is determined.

In the embodiment, a clip (Web clip data) 25 corresponding to at least a portion of the electronic document can be extracted based on the above determined clip area 22. The clip (Web clip data) is a combination of a structured text which represents an entire HTML file obtained at a given URL or a part of the HTML file, an image and a video file which are attached to the text.

Then, when the clip operation is performed, the extracted clip 25 and tag candidates (which will also be referred to as recommended tags) 26 associated with contents of the clip 25 may be displayed. The tag candidates 26 are candidates of tags to be associated with the clip 25. It should be noted that the tags are additional information items associated with clips in order to classify, search for and identify the clips. As such a tag, an arbitrary word or words, etc. can be used.

When the user performs an operation for selecting a tag to be associated with the clip 25 from among the displayed tag candidates 26 (for example, the user taps the above tag), the selected tag can be automatically associated with the clip 25. The clip 25 and the tag associated with the clip 25 are stored in the storage medium.

It should be noted that the extracted clip 25 can also be used as a search key for searching for another electronic document related to the clip 25.

In the above case, a menu including the search button may be displayed on the screen when the clip operation is performed. When it is detected that a tapping gesture is made at the position on the search button, a relevant-document search process (similar-document search process) for searching for other electronic documents related to the clip 25 is executed.

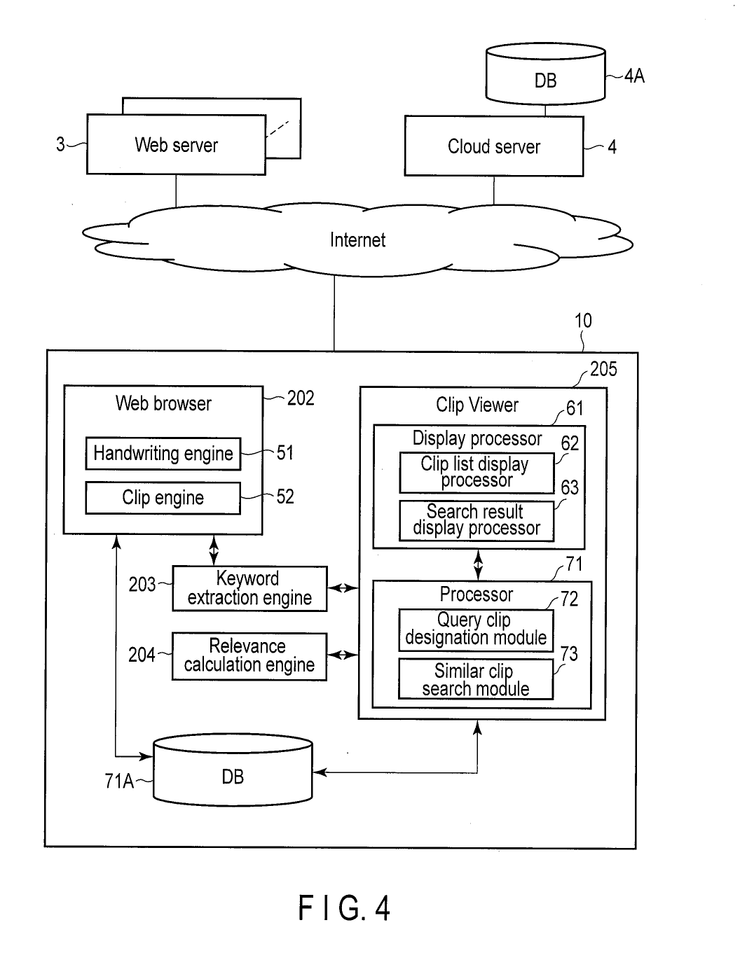

FIG. 4 shows a function configuration of programs to be executed by the tablet computer 10, i.e., a function configuration of the browser application program 202, the keyword extraction engine 203, the relevance calculation engine 204 and the clip viewer 205.

First, the browser application program (Web browser) 202 will be explained.

The browser application program 202 receives data of a Web page from a Web server 3, and displays the Web page on the screen of the LCD 17A based on the received data. To be more specific, for example, the browser application program 202 receives from the Web server 3, an HTML file associated with a URL specified by the user. Then, the browser application program 202 analyzes the received HTML file, and displays a web page associated with the received HTML file on the screen.

The browser application program 202 comprises a handwriting engine 51 and a clip engine 52.

The handwriting engine 51 comprises a drawing module and a gesture detecting module. The drawing module is configured to perform drawing on the Web page in accordance with a handwriting input operation by the user with the pen 10A or a finger of the user. The gesture detecting module is configured to detect various gestures of the user with the pen 10A or a finger of the user over the screen. During the handwriting input operation, a path of movement of the pen 10A over the screen, i.e., a stroke of handwriting (handwriting stroke) by the handwriting input operation over the screen, is drawn in real time. As a result, lines of handwriting strokes are displayed on the screen.

The clip engine 52 is a module configured to perform a clipping function. To be more specific, the clip engine 52 executes a clipping process for extracting a clip 25 from an entire Web page currently displayed or a selected area of the Web page, and storing the clip in the storage medium. Furthermore, using the keyword extraction engine 203, the clip engine 52 can also extract a plurality of keywords (e.g., some representative words) from the clip 25. In this case, the clip engine 52 may store in the storage medium, not only the clip 25, but a plurality of keywords associated with the clip 25.

Furthermore, the clip engine 52 may extract a plurality of keywords (some representative words) not only from the clip 25, but from the Web page from which the clip 25 is extracted. For example, keywords may be extracted from words (text) expressing a title of the Web page from which the clip 25 is extracted. In this case, the keywords (some words included in the title) extracted from the Web page from which the clip 25 is extracted may be stored as keywords associated with the clip 25 in the storage medium, as the keywords associated with the clip 25.

As the above storage medium, a database (DB) 4A on a cloud server 4 or a local database (DB) 71A in the tablet computer 10 can be used. The local DB 71A is a storage region in, e.g., the storage device 106.

Next, the relevance calculation engine 204 will be explained. The relevance calculation engine 204 calculates a degree of relevance between an attentional document from which keywords have been extracted and a document to be processed from which keywords have also been extracted. The above degree of relevance (similarity) may be calculated based on, e.g., a plurality of first keywords extracted from the attentional document and a plurality of second keywords extracted from the document to be processed.

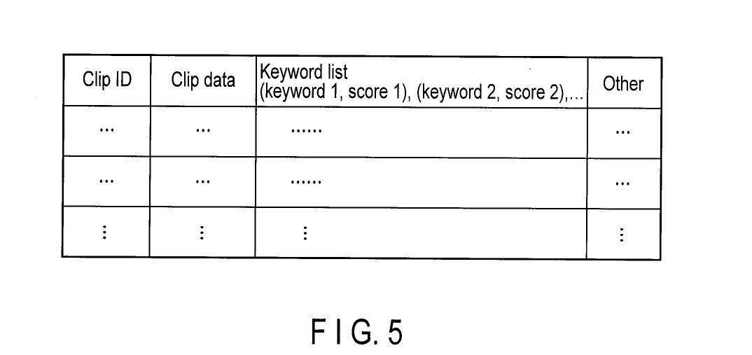

FIG. 5 shows an example of a structure of clip data stored in the DB 4A or the DB 71A.

The DB 4A or the DB 71A has a plurality of entries associated with a plurality of clips. In such a manner, the entries are associated with the clips, respectively. Each of the entries includes clip ID, clip data and a keyword list.

In an entry associated with a given clip, “clip ID” is identification information given to the clip. “Clip data” includes a structured text configured to specify an entire HTML file associated with the clip or part of the HTML file, and an image, etc., attached to the text. The keyword list includes keywords associated with the clip and scores respectively given to the keywords. Furthermore, in each of the entries, words (text) expressing a title of the document from which the clip is extracted may be stored.

As shown in FIG. 4, the clip viewer 205 comprises a display processor 61 and a processor 71.

The display processor 61 takes out a plurality of clips (a plurality of clip data) from the DB 4A or the DB 71A. Each of the clips, as described above, is produced from an electronic document such as a Web page or part of the electronic document. A clip list display processor 62 included in the display processor 61 displays on the LCD 17A, a view (clip list viewing screen) in which the taken-out clips can be viewed. The display processor 61 can simultaneously display some clips in the clip list viewing screen. In this case, those clips may be displayed in the same size. In the case of displaying a clip having a greater size than those of the above clips, only part of the clip may be displayed or the clip may be reduced.

The clip viewer 205 has two kinds of search functions for enabling the user to easily search for a desired clip from among a large number of clips stored in the DB 4A (or the DB 71A). One of the search functions is a keyword search.

The keyword search is a process for acquiring information regarding one or more clips which have contents corresponding to a search keyword input to a search key input area by the user. That is, in the keyword search, one or more clips corresponding to the search keyword input by the user are searched for. In the keyword search, a clip or clips including keywords identical to the search keyword are presented to the user as a search result.

The keyword search is made by the processor 71. Alternatively, the keyword search may be made by the cloud server 4. In this case, the clip viewer 205 sends the search keyword input by the user to the cloud server 4 as a search request, and can thus acquire from the cloud server 4, information regarding one or more clips which have contents corresponding to the search keyword.

However, in the keyword search, it is hard to find a desired clip for the user, unless the user inputs an accurate search keyword. Particularly, if several hundreds of or more clips are stored in the DB 4A (or the DB 71A), there is a case where a desired clip, i.e., a specific clip which the user wishes to find, is hard to find, even if a keyword search is made using one or more search keywords input by the user. For example, there is case where several tens of search clips are presented to the user as a search result. It is not easy for the user to check each of the several tens of clips. Alternatively, there is a case where a specific clip which the user wishes to find is not searched for if the input search keyword is not appropriate.

In view of the above, the clip viewer 205 is formed to have a function of performing a similar clip search, in addition to the keyword search.

The similar clip search is performed with the above function of the relevant-document search process. The similar clip search is a function of searching for, using a clip itself which is selected by the user, other clips related (similar) to the selected clip. Thus, the similar clip search is not made using a search keyword input by the user. To be more specific, in the similar clip search, a stored clip (query clip) itself which is selected in accordance with an operation by the user is designated as a certain kind of search key. Then, in the similar clip search, information regarding one or more stored clips related to the query clip is acquired. The information regarding one or more stored clips related to the query clip is determined based on the relevance between the query clip and each of the stored clips. The relevance between the query clip and each stored clip is calculated using a plurality of keywords associated with the query clip and a plurality of keywords associated with each stored clip.

It should be noted that electronic documents to be searched is not limited to stored clips, and for example, all kinds of electronic documents stored in the above storage medium may be searched.

In order to make the similar clip search, the processor 71 comprises a query clip designation module 72 and a similar clip search module 73. The query clip designation module 72 designates as a search key, a first clip of a plurality of clips acquired from the DB 4A (or the DB 71A) in accordance with an operation by the user on the clip list viewing screen. In this case, the touch screen display 17 may function as an input device capable of designating the above first clip as a search key.

The similar clip search module 73 executes the relevant-document search process to acquire information regarding some electronic documents (some content) related (similar) to the first clip (query clip), in cooperation with the relevance calculation engine 204.

In the relevant-document search process, documents including similar elements are determined to have relevance to each other. That is, in the relevant-document search process, for example, content including an element which is the same as or similar to a given element in the query clip is determined as relevant content related (similar) to the query clip. This element, for example, is the above keyword. The information regarding some content related to the query clip can be acquired by calculating a degree of relevance between the query clip and each of content to be searched for, using a plurality of keywords associated with the query clip and a plurality of keywords associated with each of content to be searched for. The keywords associated with each of content to be searched for are extracted from said each content.

It should be noted the above element is not limited to a keyword; that is, any kind of element (data) may be applied as the above element as long as it is an element included in the query clip. For example, if the query clip is a Web clip, not only a keyword (word) extracted from the Web clip, but a hand-written object (e.g., a hand-written character string) in the Web clip or an image in the Web clip may be applied as an element of the Web clip (query clip).

It should be noted that the above relevant-document search process can also be executed by the cloud server 4. In this case, the clip viewer 205 sends as a search request, a search key (information regarding a query clip designated in accordance with an operation by the user) to the cloud server 4. Then, the clip viewer 205 receives, from the cloud server 4, information regarding some relevant content related to the query clip. In such a manner, the clip viewer 205 can acquire the information regarding the relevant content from the cloud server 4.

A search result display processor 63 included in the display processor 61 displays some relevant content related to the query clip in a search result screen.

In many cases, the query clip includes a plurality of elements (e.g., a plurality of words). Furthermore, in the relevant-document search, the user does not need to input a search keyword. Also, there may be a case where the user wishes to find through intuition, a clip having a similar appearance to that of a certain clip. In this case, there is also a case where the user does not grasp individual elements (words, images, hand-written objects, etc.) included in the query clip.

Therefore, in the relevant-document search, in the case where some relevant content related to the query clip is simply displayed on the screen, even if each of those relevant content has high relevance to the query clip, there is a case where the user can not easily understand why those relevant content have high relevant to the query clip.

Therefore, in the embodiment, the search result display processor 63 has a function of displaying in the search result screen, information for explaining the relevance between the query clip and each of the relevant content. As the information for explaining the relevance between the query clip and the relevant content, for example, information regarding a common element for the query clip and the relevant content may be applied.

For example, when first relevant content which is related to the query clip with respect to a first element of the query clip is displayed in the search result screen, i.e., if the first element is a common element for the query clip and the first relevant content, the search result display processor 63 displays the first relevant content in the search result screen, in a form capable of specifying information regarding the first element. That is, the search result display processor 63 displays the first relevant content and a first indication on the screen, the first indication regarding that the first relevant content is related to the first element.

Furthermore, when second relevant content which is related to the query clip with respect to a second element of the query clip is displayed in the search result screen, i.e., if the second element is a common element for the query clip and the second relevant content, the search result display processor 63 displays the second relevant content in the search result screen, in a form capable of specifying information regarding the second element. That is, the search result display processor 63 displays the second relevant content and a second indication on the screen, the second indication regarding that the second relevant content is related to the second element.

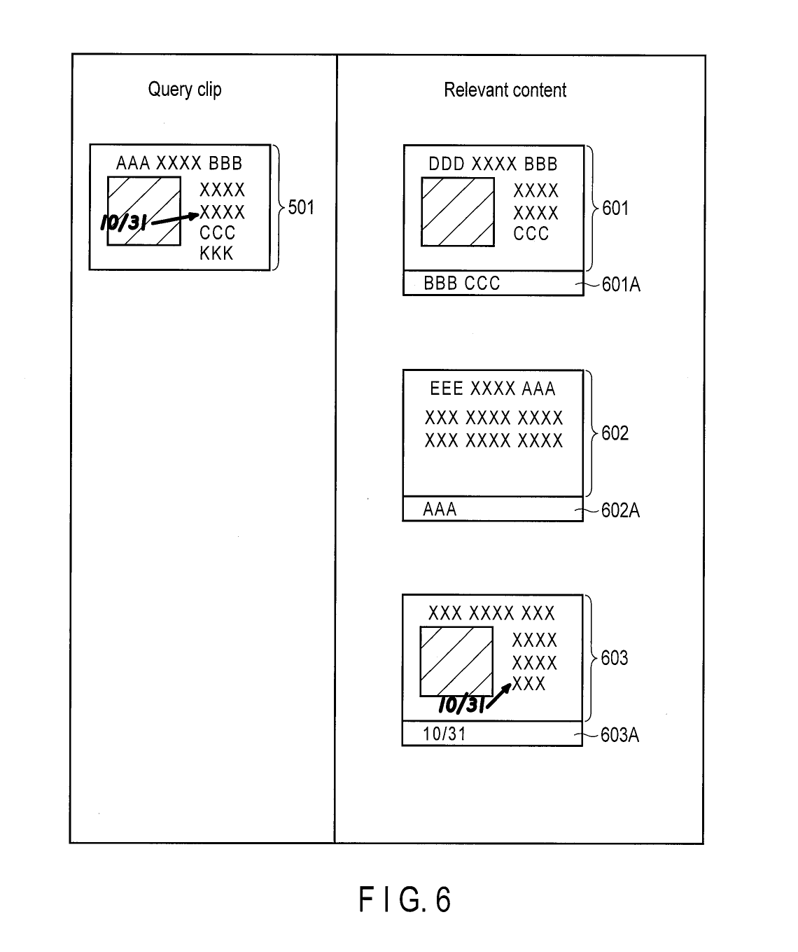

FIG. 6 shows a display example of each relevant content in the search result screen.

The following explanation is given with respect to the case where a clip 501 is designated as a query clip, and content 601, content 602, content 603, . . . are searched for as relevant content related to the clip 501. In the search result screen, the query clip 501 and some relevant content (relevant clips) are displayed at the same time. In this case, those clips are all displayed in the same size. Thus, as described above, with respect to a larger clip, there is a case where only part of the clip is displayed. However, in order to simply the explanation, FIG. 6 shows the case the entire clips are displayed.

A text of the clip 501 includes words “AAA”, “BBB”, “CCC”, “KKK”, etc., and that of the content 601 includes words “DDD”, “BBB”, “CCC”, etc. In this case, suppose in the clip 501, the words “AAA”, “BBB”, “CCC” and “KKK” are important keywords having high scores, and in the content 601, the words “DDD”, “BBB” and “CCC” are important keywords having high scores.

The clip 501 and the content 601 include common keywords (“BBB” and “CCC”). That is, the content 601 is relevant content (relevant document) related to the clip 501 with respect to two elements (keywords “BBB” and “CCC”) of the clip 501. In this case, the search result display processor 63 displays the content 601 on the screen in a form which enables information regarding the two elements (the keywords “BBB” and “CCC”) to be specified. In the example of FIG. 6, a relevant information display area 601A is displayed under the content 601 as the indication regarding that the content 601 is related to the two elements (the keywords “BBB” and “CCC”). The search result display processor 63 displays the above two elements (the keywords “BBB” and “CCC”) as information for explaining the relevance between the clip 501 and the content 601, in the relevant information display area 601A. When being displayed under the content 601, the relevant information display area 601A may be located so as not to overlap with the content 601 or so as to overlap with the content 601.

In such a manner, since the two common elements (the keywords “BBB” and “CCC”) are displayed in the relevant information display area 601A, even if the user does not grasp individual elements (words or the like) of the clip 501, the user can know with respect to what elements (words or like) the clip 501 and the content 601 are similar to each other.

Furthermore, in the case where only part of the content 601 is displayed in the search result screen, not all keywords of the content 601 are necessarily displayed. For example, there is a case where the keywords “BBB”, “CCC”, etc. are out of view. Also, there is a case where a word having a small size in the content 601 cannot be easily viewed by the user. Therefore, in the embodiment, since a plurality of common elements are displayed in the relevant information display area 601A, it is possible for the user to easily understand with respect to what elements (words or like) the clip 501 and the content 601 are similar to each other.

The clip 501 and the content 602 include the common important keyword “AAA”. Thus, the content 602 is relevant content related to the clip 501 with respect to the above single element (the keyword “AAA”) extracted from the clip 501. In this case, the search result display processor 63 displays the content 602 on the screen in a form which enables information regarding the single element (the keyword “AAA”) to be specified. To be more specific, a relevant information display area 602A is displayed under the content 602 as the indication regarding that the content 602 is related to the element (the keyword “AAA”). In the relevant information display area 602A, the above single element (the keyword “AAA”) is displayed.

The clip 501 and the content 603 include the common handwritten character string “10/31”. That is, the content 603 is relevant content (relevant document) related to the clip 501 with respect to the above single element (the handwritten character string “10/31”) extracted from the clip 501. In this case, the search result display processor 63 displays the content 603 on the screen in a form which enables information regarding the single element (the handwritten character string “10/31”) to be specified. To be more specific, the relevant information display area 603A is displayed under the content 603 as the indication regarding that the content 603 is related to the element (the handwritten character string “10/31”). In the relevant information display area 603A, the above single element (e.g., reorganization result of the handwritten character string “10/31”) is displayed.

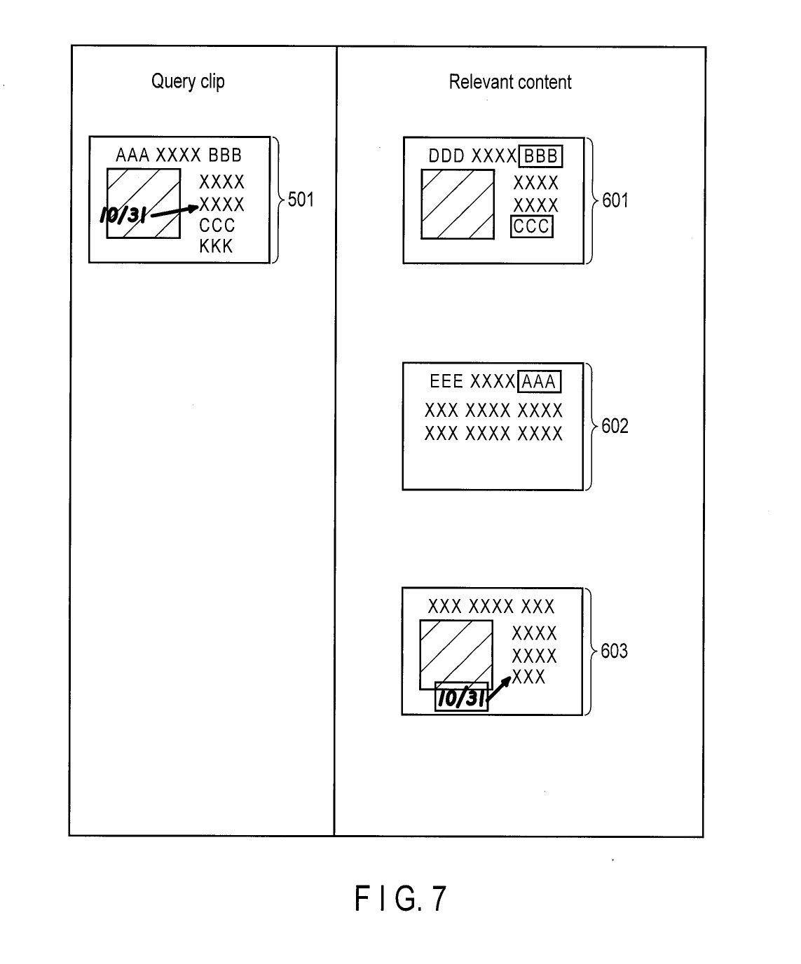

FIG. 7 shows another display example of the relevant content in the search result screen.

As to the content 601, the keywords “BBB” and “CCC” in the content 601 are displayed to be highlighted. That is, the keywords “BBB” and “CCC” are displayed along with an indication for highlighting. As to the content 602, the keyword “AAA” in the content 602 is displayed in such a way as to be highlighted. As to the content 603, the handwritten character string “10/31” in the content 603 is displayed to be highlighted.

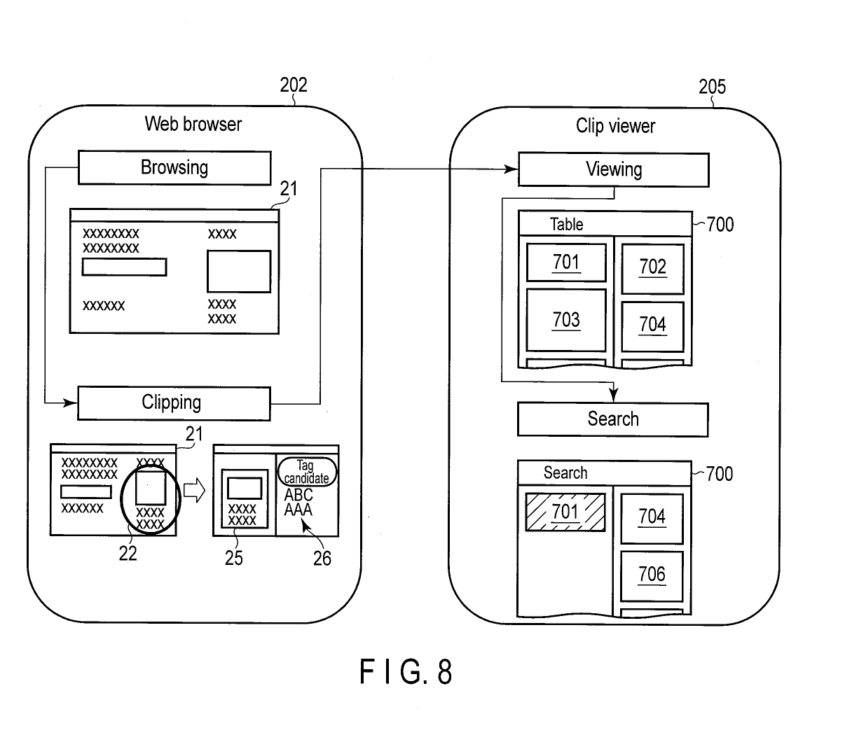

FIG. 8 is a view for use in explaining a series of processes to be executed by the tablet computer 10.

The browser application program 202 executes a browsing process and a clipping process. In the browsing process, the browser application program 202 displays a Web page 21. The clipping process is a process for storing a clip (Web clip) corresponding to at least part of the Web page 21, in the storage medium. When the user performs a clip operation for specifying a clip area 22 on the Web page 21, the browser application program 202 stores an extracted clip 25 and a plurality of keywords associated with the clip 25, in the storage medium, e.g., the DB 4A or the DB 71A.

The clip viewer 205 executes a viewing process for viewing a list of stored clips and a relevant-document search process for searching for a desired clip. In the viewing process, the clip viewer 205 displays a clip list viewing screen 700. The clip list viewing screen 700 is a view capable of presenting a plurality of clips stored in the DB 4A (or the DB 71A) to a user. FIG. 8 shows by way of example that clips 701, 702, 703, 704 . . . are displayed in the clip list viewing screen 700.

Suppose the user selects the clip 701 as a clip to be noted, for the relevant-document search. In this case, the clip viewer 205 designates the selected clip 701 as a search key (query clip), and executes a relevant-document search process for searching for a clip related to the clip 701.

FIG. 8 shows the case where clips 704 and 706 are searched for as relevant clips. The clip viewer 205 sorts the relevant clips searched for, in a descending order of degree of relevance, and displays those relevant clips on the screen such that the higher the degree of relevance of the relevant clip, the higher the position of the relevant clip in the screen.

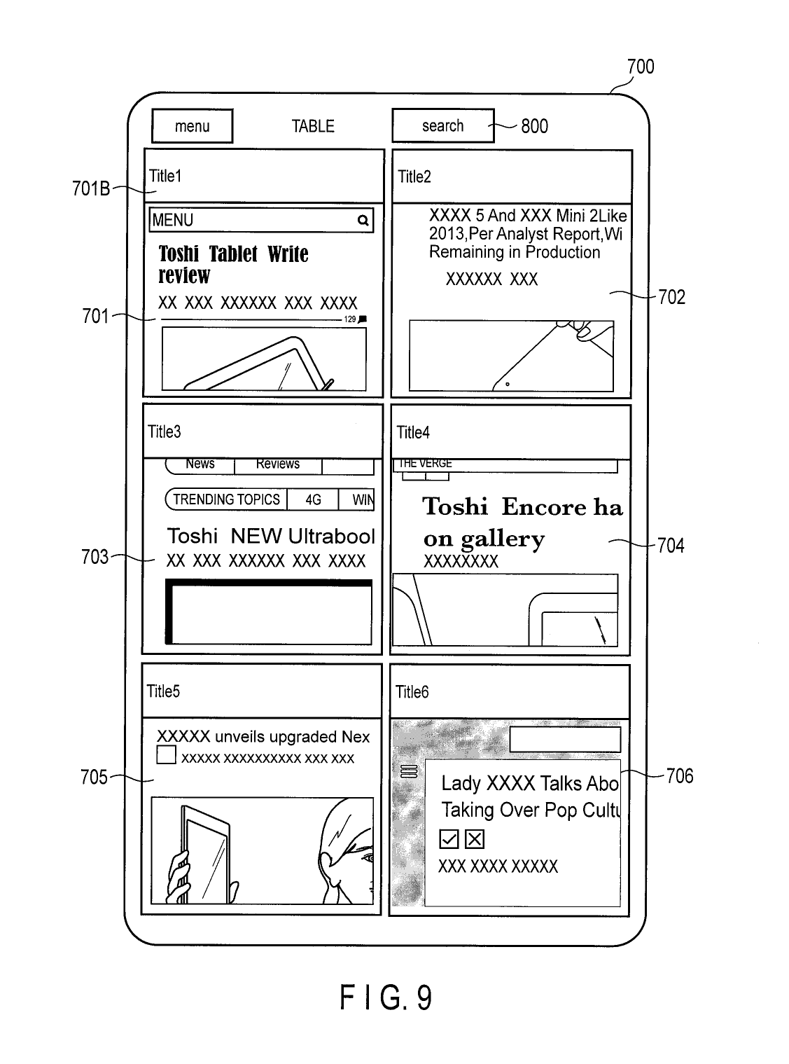

FIG. 9 shows an example of a way of displaying clips in the clip list viewing screen 700.

The clip list viewing screen 700 can be displayed in two display modes, i.e., a clip viewing mode (TABLE) and a clip search mode (SEARCH). The clip viewing mode (TABLE) is a display mode for displaying a list of Web clips stored. In the clip viewing mode, as shown in FIG. 9, a plurality of clips stored (the clips 701-706 as shown in the figure) are displayed. For example, a plurality of thumbnail images corresponding to the plurality of clips (the clips 701-706) may be displayed in the clip list viewing screen 700.

The clips 701-706 may be displayed in chronological order in the clip list viewing screen 700 such that the later the date and time at which the clip was produced (it was stored), the higher the position of the clip in the clip list viewing screen 700. In the clip list viewing screen 700, the clips may be displayed such that they have the same length in a horizontal direction and also the same length in a vertical direction. Alternatively, the clips may be displayed such that they have the same length in the horizontal direction, and have different lengths in the vertical direction.

When swiping or the like by a finger is detected at the location on the clip list viewing screen 700, the clip viewer 205 scrolls a clip list in the vertical direction to change clips to be displayed in the clip list viewing screen 700. Therefore, even if a larger number of clips are stored in the DB 4A than the number of clips which can be simultaneously displayed in the clip list viewing screen 700, the user can easily view arbitrary clips.

In an upper area of each of the clips, a title display area is displayed. The title display area is a display area for displaying words (text) expressing a title of a document (Web page) from which an associated clip is extracted. For example, as to the clip 701, in a title display area 701B displayed in an upper area of the clip 701, words (text) expressing a title of a document (Web page) from which the clip 701 is extracted is displayed. In FIG. 9, “Title1” is indicated in the title display area 701B in order that it is simply explained. However, actually, in the title display area 701B, words (text) expressing a title is displayed. Similarly, as to each of the other clips, in the title display area, words (text) expressing a title of a document (Web page) from which an associated clip is extracted is displayed.

In the above relevant-document search process, not only words included in a text in a clip, but words (text) expressing the title of the document from which the clip is extracted are used as keywords for the clip.

A button 800 is provided as a user interface for switching the display mode between the clip viewing mode (TABLE) and the clip search mode (SEARCH). In the button 800, a label indicating a display mode to be applied by switching is displayed.

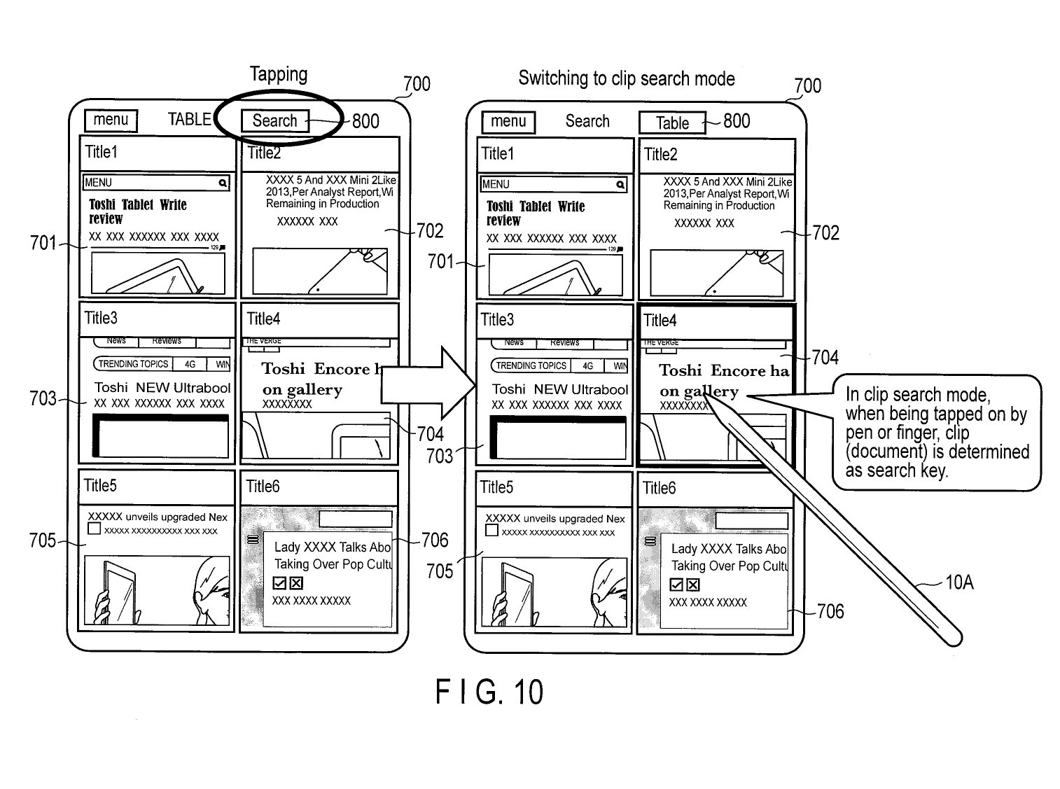

In the clip viewing mode (TABLE), at the position of the button 800, when a tapping gesture or the like is detected, the display mode, as shown in FIG. 10, is switched from the clip viewing mode (TABLE) to the clip search mode (SEARCH).

In the clip search mode (SEARCH), the user can select a desired clip to be determined as a search key (query clip), by tapping on the desired clip with the pen 10A or a finger.

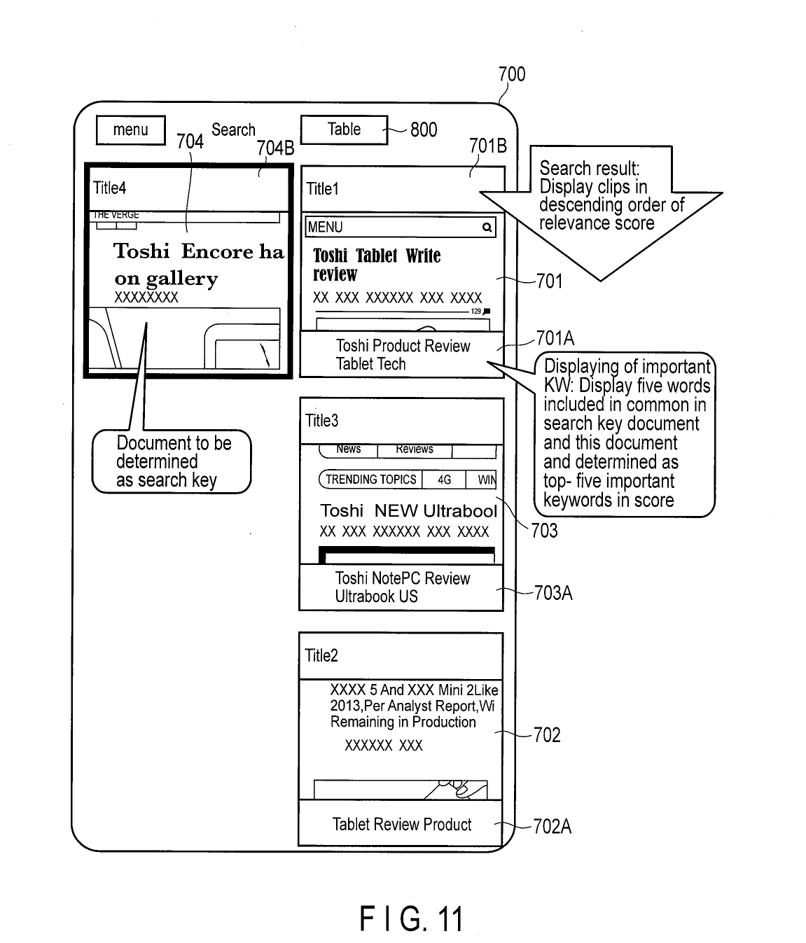

As shown in FIG. 10, when the clip 704 is tapped on by the pen 10A, it is designated as a search key (query clip). Then, such a search result screen as shown in FIG. 11 is displayed.

In the search result screen as shown in FIG. 11, the clip 704 designated as the search key is displayed in upper part of a left area of the screen, and relevant clips which are searched for by the relevant-document search process are displayed in a right area of the screen. The relevant clips are sorted in the order of degree of relevance such that the higher the degree of relevance of the clip, the higher the position of the clip in the screen. As can be seen from the search result screen as shown in FIG. 11, FIG. 11 shows the case where the clips 701, 703 and 702 are searched for as relevant clips.

In a relevant information display area 701A located under the clip 701, information for explaining the relevance between the clip 704 and the clip 701 is displayed. For example, common keywords which are included in common in a list of keywords for the clip 704 and a list of keywords for the clip 701 are displayed in the relevant information display area 701A. In most cases, with respect to those common keywords, the clip 701 is related to the clip 704. Therefore, the common keywords displayed enable the user to understand on what point the clip 704 and the clip 701 are related to each other.

Alternatively, of the common keywords, some common keywords which have great importance (high scores) for the clip 704 and the clip 701 may be displayed in the relevant information display area 701A. For example, of the common keywords, top-five keywords having great importance (high scores) may be displayed in the relevant information display area 701A.

FIG. 11 shows the case where the words “Toshi”, “Product”, “Review”, “Tablet” and “Tech” are common keywords having great importance. With respect to the clip 704, the above words are included in the text in the clip 704 or a title display area 704B in the clip 704. Similarly, with respect to the clip 701 also, the above words are included in the text in the clip 701 or a title display area 701B in the clip 701.

In a relevant information display area 703A located under the clip 703, of keywords which are included in common in a list of keywords for the clip 704 and a list of keywords for the clip 703, top-five keywords having great importance (high scores) for those clips are displayed.

In a relevant information display area 702A located under the clip 702, of keywords which are included in common in the list of keywords for the clip 704 and a list of keywords for the clip 702, top-five keywords having great importance (high scores) for those clips are displayed.

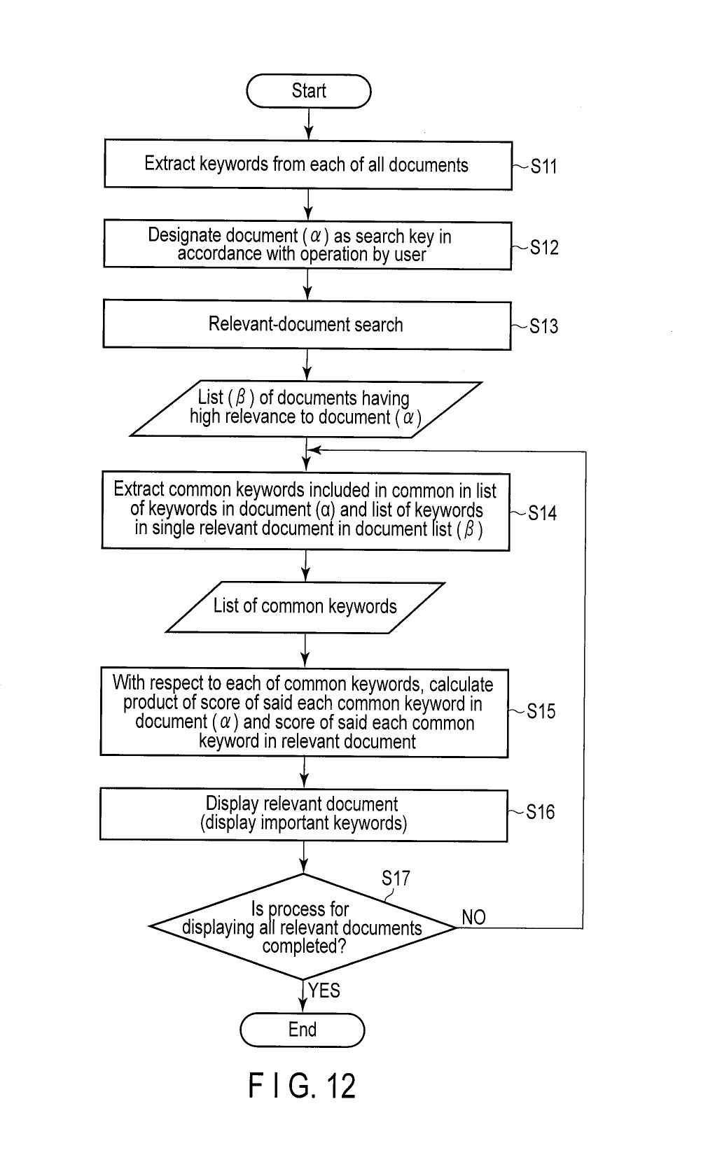

A flowchart of FIG. 12 shows a procedure of a process for displaying relevant clips relevant to the query clip.

The clip viewer 205 extracts a plurality of keywords, using the keyword extraction engine 203, from each of all recorded clips (documents) (step S11). If the keywords in all the recorded clips are stored in a database, the clip viewer 205 can acquire the keywords from the database. Then, the clip viewer 205 designates a single clip (document (α)) of the above recorded clips as a search key (query clip) in accordance with an operation by the user on the clip list viewing screen 700 in which the recorded clips are displayed (step S12).

Then, the clip viewer 205 executes the relevant-document search process with the relevance calculation engine 204 to acquire information regarding one or more clips (documents) related to the query clip (document (α)) (step S13). In the step S13, the relevance calculation engine 204 calculates a degree of relevance between the query clip and each of other clips to be processed. Thereby, a list (document list (β)) of relevant clips having high relevance to the query clip (document (α)) is acquired.

The clip viewer 205 selects a single relevant clip (relevant document) from the document list (β)), and acquires a list of keywords corresponding to the query clip (document (α)) and a list of keywords corresponding to the selected relevant clip (relevant document). Then, common keywords which are included in common in the above lists of keywords are extracted (step S14). In such a manner, a list of common keywords which are included in common in the query clip and the selected relevant clip can be obtained.

The clip viewer 205 determines whether each of the common keywords is an important keyword for the query clip and the selected relevant clip or not. To be more specific, the clip viewer 205 calculates a product of a score of a common keyword in the query clip (document (a)), which is to be subjected to the above determination, and a score of the common keyword in the selected relevant clip (step S15). If the product is equal to or higher than a threshold, the clip viewer 205 determines the above common keyword to be subjected to the determination, as an important keyword for the query clip and the selected relevant clip.

In such a manner, the clip viewer 205 acquires a list of important common keywords for each of the relevant clips (relevant documents). Then, the clip viewer 205 displays some important common keywords along with a relevant clip (relevant document) (step S16). The clip viewer 205 repeatedly executes processes of steps S14-S16 until the process for displaying all the relevant clips (relevant documents) is completed.

As explained above, in the embodiment, a first clip included in the stored clips is designated as a search key in accordance with an operation by the user on the clip list viewing screen 700. Then, information regarding one or more other stored relevant clips related to the first clip is acquired. Therefore, based on a clip designated in accordance with the operation by the user on the clip list viewing screen 700, another clip whose contents are related to the above designated clip can be easily found without inputting an accurate search keyword. Thus, even if a large number of clips are stored, the user can easily find a desired clip to be reused.

Furthermore, if a first relevant clip searched for is related to the first clip with respect to a first element of the first clip, the first relevant clip is displayed in the search result screen in a form capable of specifying information regarding the first element of the first relevant clip. That is, the first relevant clip and a first indication regarding that the first relevant content is related to the first element are displayed.

Also, if a second relevant clip searched for is relevant to the first clip with respect to a second element of the first clip, the second relevant clip is displayed in the search result screen in a form capable of specifying information regarding the second element of the second relevant clip. That is, the second relevant clip and a second indication regarding that the second relevant content is related to the second element are displayed.

Therefore, each of the relevant content can be displayed in such a manner as to enable the user to easily understand why each of the relevant content is searched for as content having high relevance. Thus, the processing of the embodiment can help the user find desired content.

It should be noted that the above explanation of the embodiment is given mainly with respect to the case of handling a clip corresponding to a Web page or part thereof. However, in the embodiment, a clip corresponding to an arbitrary kind of electronic document or part thereof can also be handled in the same manner as explained above.

Furthermore, each of the processes in the embodiment can be executed by a computer program. Thus, it is possible to easily obtain the same advantage as in the embodiment simply by installing the above computer program onto an ordinary computer with a computer-readable storage medium storing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a processor configured to designate a first clip corresponding to at least a portion of an electronic document as a search key, the first clip including a first element and a second element, and acquire information regarding a plurality of contents related to the first clip as a search result, the plurality of contents including a first content and a second content; and
a display processor configured to display on a screen the plurality of contents;
wherein if the first content relates to the first element, the display processor is configured to display the first content and a first indication on the screen, the first indication regarding that the first content is related to the first element, and
if the second content relates to the second element, the display processor is configured to display the second content and a second indication on the screen, the second indication regarding that the second content is related to the second element.

2. The electronic device of claim 1, wherein:
the display processor is configured to display a plurality of clips on the screen, each of the plurality of clips corresponding to at least a portion of an electronic document;
the first clip is selected from the plurality of clips; and
the plurality of contents correspond to a plurality of second clips of the plurality of clips, and the plurality of second clip relate to the first clip.

3. The electronic device of claim 1,
wherein the information regarding the plurality of contents is determined based on relevance between the first clip and each of a plurality of content to be searched for, the relevance calculated using a first plurality of keywords corresponding to the first clip and a second plurality of keywords corresponding to the each of the plurality of content to be searched for.

4. The electronic device of claim 1,
wherein the first and second elements correspond to first and second keywords respectively, and both corresponding to the first clip.

5. The electronic device of claim 1, wherein:
the first element is a first common keyword for the first clip and the first content; and
the second element is a second common keyword for the first clip and the second content.

6. A method of processing a clip by an electronic device comprising:
designating a first clip associated with at least a portion of an electronic document as a search key, the first clip including a first element and a second element;
acquiring information regarding a plurality of contents related to the first clip as a search result, the plurality of contents including a first content and a second content; and
displaying on a screen the plurality of contents,
wherein the displaying further comprises:
displaying, if the first content relates to the first element, the first content and a first indication on the screen, the first indication regarding that the first content is related to the first element, and
displaying, if the second content relates to the second element, the second content and a second indication on the screen, the second indication regarding that the second content is related to the second element.

7. The method of claim 6,
further comprising displaying a plurality of clips on the screen, each of the plurality of clips corresponding to at least a portion of an electronic document,
wherein:
the first clip is selected from the plurality of clips; and
the plurality of contents correspond to a plurality of second clips of the plurality of clips, and the plurality of second clip relate to the first clip.

8. The method of claim 6,
wherein the information regarding the plurality of contents is determined based on relevance between the first clip and each of a plurality of content to be searched for, the relevance calculated using a first plurality of keywords corresponding to the first clip and a second plurality of keywords corresponding to the each of the plurality of content to be searched for.

9. The method of claim 6,
wherein the first and second elements correspond to first and second keywords respectively, and both corresponding to the first clip.

10. The method of claim 6, wherein:
the first element is a first common keyword for the first clip and the first content; and
the second element is a second common keyword for the first clip and the second content.

11. A computer-readable, non-transitory storage medium having stored thereon a computer program which is executable by a computer, the computer program controlling the computer to execute functions of:
designating a first clip associated with at least a portion of an electronic document as a search key, the first clip including a first element and a second element;
acquiring information regarding a plurality of contents related to the first clip as a search result, the plurality of contents including a first content and a second content; and
displaying on a screen the plurality of contents,
wherein the displaying comprises:
displaying, if the first content relates to the first element, the first content and a first indication on the screen, the first indication regarding that the first content is related to the first element, and
displaying, if the second content relates to the second element, the second content and a second indication on the screen, the second indication regarding that the second content is related to the second element.

12. The storage medium of claim 11,
wherein the computer program further controlling the computer to execute functions of displaying a plurality of clips on the screen, each of the plurality of clips corresponding to at least a portion of an electronic document,
wherein:
the first clip is selected from the plurality of clips; and
the plurality of contents correspond to a plurality of second clips of the plurality of clips, and the plurality of second clip relate to the first clip.

13. The storage medium of claim 11,
wherein the information regarding the plurality of contents is determined based on relevance between the first clip and each of a plurality of content to be searched for, the relevance calculated using a first plurality of keywords corresponding to the first clip and a second plurality of keywords corresponding to the each of the plurality of content to be searched for.

14. The storage medium of claim 11,
wherein the first and second elements correspond to first and second keywords respectively, and both corresponding to the first clip.

15. The storage medium of claim 11, wherein:
the first element is a first common keyword for the first clip and the first content; and
the second element is a second common keyword for the first clip and the second content.
